(19) United States
(12) Patent Application Publication
(10) Pub. No.: US 2013/0335972 A1
(43) Pub. Date: Dec. 19, 2013

(54) MAST

(71) Applicants: Hannes Hübner, Heinersreuth (DE); Werner Spessert, Waischenfeld (DE)

(72) Inventors: Hannes Hübner, Heinersreuth (DE); Werner Spessert, Waischenfeld (DE)

(73) Assignee: GEROH GMBH & CO. KG, Waischenfeld (DE)

(21) Appl. No.: 13/883,728

(22) PCT Filed: Nov. 7, 2011
(86) PCT No.: PCT/EP2011/005591

§ 371 Date: Aug. 29, 2013

(30) Foreign Application Priority Data
Nov. 8, 2010 (DE) 10 2010 050 716.4

(51) Int. Cl. E04H 12/18; F21V 33/00; E04H 12/34

(52) U.S. Cl. CPC E04H 12/182; E04H 12/344; F21V 33/00
USPC 362/253; 52/110

(57) ABSTRACT

The invention relates to a mast having a functional arrangement comprising an active area (5), by means of which the environment of the mast can be affected and/or the effect of the mast environment can be registered, and having a second segment (2, 2′) telescopically displaceable along the mast axis relative to a first segment (1, 2) of the mast and enclosed circumferentially by the first segment with respect to the mast axis in a collapsed state and comprising an exposed shell area (4) in the extended state, wherein the active area (5) extends at least partially across the shell area (4).¹ ¹Translator's note: For consistency I have used the translation of words/terms throughout in line with the abstract accompanying the diagram on the first page, although there could be different variations, e.g. ‘section’ for ‘segment’ etc., which would also be valid.

The invention relates to a mast with a functional arrangement comprising an active area over which the environment of the mast can be affected and/or the effect of the mast environment can be registered, and having a second segment telescopically displaceable along the mast axis relative to a first segment, which is enclosed circumferentially by the first segment with respect to the mast axis in a collapsed state and comprising an exposed shell area in the extended state, as well as a vehicle equipped with such a mast.

Such extendable masts, described as telescopic masts, are well established. They carry, for example, transmitting and receiving devices, measuring equipment, cameras, searchlights or similar functional arrangements, which can be fitted to the mast top either directly or with a supporting adapter. The masts themselves are often fitted to vehicles, for example fire, ambulance or police vehicles, so that when these vehicles are deployed the mast can be transported to the incident site in a collapsed state without causing an obstruction; the functional arrangement can subsequently be quickly moved to the desired operating height by extending the mast.

As an example may be mentioned here an accident occurring at night, where the incident location must be illuminated by the approaching emergency services, in order to be able to survey the area to its full extent and to start their rescue work. For this, one or several adjustable searchlights, partially driven by electric motor adjustment units¹, will be used as a functional arrangement to illuminate the accident site from above after extending the mast to the desired height. ¹Translator's note: I think in the original sentence ‘beschrieben’ should in fact have been ‘betrieben’ and this is translated accordingly.

It has, however, turned out that during such emergency deployments it has been difficult for aid workers to take appropriate measures using conventional telescopic masts. The task of providing a telescopic mast whose use makes possible improved, and in particular quicker, aid measures underlies the invention.

The problem is solved by this invention through the development of a mast of the type described at the start, which is mainly characterised by the fact that the active area extends, at least partially, over the shell area.

In this way, in the above example the functional arrangement of light sources used for illumination can be deployed over a greater mast height range, whereby improved near-field illumination around the mast is achieved. The required aid measures can be initiated better and more quickly because of the improved lighting.

The active area of the mast axis is so small in radial dimension that the functional arrangement is basically ready to operate in its collapsed state and is ready for use immediately following extension of the mast. The mast is correspondingly collapsible without dismantling the functional arrangement. The active area of the functional arrangement is therefore integrated into the telescopic mast. Good near-field illumination, or the use of another functional arrangement as a lighting installation, without additional time loss above the time required to extend the mast, is thus achieved.

As already explained above, the functional arrangement can perform a function using signal and/or lighting technology; measuring equipment and cameras can, however, be used, which have less to do with an effect on the mast environment but more with the registering of that environment. Here the active area of the functional arrangement does not indicate any function of the parts or accessories ancillary to the arrangement, but rather the area over which these effects or interactions take place, i.e. the light sources in the case of a lighting arrangement, or antennae, sensors, etc.

The exposure of the shell area in the extended state must be seen in contrast to the situation in the collapsed state, where the shell area of a segment lies inside the neighbouring lower mast segment.

With respect to the type of retraction technology, pneumatic masts, cable masts, spindle masts or even lattice masts are basically possible; pneumatic mast designs are, however, especially suitable and are therefore preferred.

In one preferred design, more than two mast segments are envisaged and the active area stretches over more than one segment. In this way the effect of the functional arrangement can be distributed evenly over the mast height so that, in the case of a lighting arrangement, glare-free near-field illumination is made possible. It is also envisaged that the active area can extend over the lowest segment of the telescopic mast, which is also already exposed in the collapsed state. The active area is usefully extended by over 10% or more in an extended mast, 40% or more being especially preferred and, most especially, 80% or more of the mast height. The freedom from glare of the near-field illumination produced can thus be further improved.

In an especially preferred design, the extension of the active area extends over the full periphery of the shell area. Circular near-field illumination is thus achieved. For this, however, the full peripheral surface of the shell area must not be aligned in the peripheral direction of the active area. The active area can in fact also comprise several sub-areas separated from each other which, for example, extend, spaced out from one another, over the full periphery the shell area.

In one practical design the mast top is designed for the attachment of further functional arrangements. The near-field illumination achieved can thus be combined for instance with the searchlights mounted on the mast top, permitting targeted illumination of individual areas within the mast environment.

The mast foot is appropriately designed for fastening to a vehicle. As already explained above, quick transport of the mast to the deployment location is thereby made possible if the telescopic mast is carried by an emergency vehicle. Through the integrated signal and/or illumination technology the telescopic mast according to the invention can also be fitted to comparatively smaller vehicles, which can reach an accident spot more quickly and selectively guide heavier vehicles moving up by their quick illumination.

As emerges from the above explanations, the mast according to the invention is especially advantageous for a functional arrangement acting as a lighting arrangement. In this context it is particularly envisaged that the lighting arrangement displays 12 or more separate light sources, 60 or more being preferred and, especially, 100 or more. In this way a higher redundancy factor is achieved and, even on the failure of one or several light sources, the mast remains operationally secure with regard to its lighting function.

The light sources preferably have a height density of 4 per metre or more, especially 20 per metre or more and, most especially, 50 per metre or more. This leads to a more even near-field illumination. It is furthermore usefully envisaged that the light sources have a peripheral density of 2 or more, preferably 4 or more and especially 6 or more (related to the full periphery of the shell area), which makes more evenly distributed circular near-field illumination possible.

By using numerous light sources they can also be operated at a lower output, thereby improving the freedom from glare and uniformity of the near-field illumination.

In order to utilise the energy used for lighting advantageously it is, for practical purposes, envisaged that the lighting arrangement, or at least one of its light sources, has an especially adjustable/adjusted height dependent main radiation direction.

For the same reasons it is desirable that 60% or more, preferably 70% or more, and most especially 80% or more of the radiation output will be radiated in the angular range π/2≦θ≦π, whereby these angular values relate to the usual spherical coordinates of the mast axis as a z-axis, and thus the radiation takes place predominantly horizontally to vertically downward (with a vertical mast).

The active areas of the functional arrangement, which are in part quite sensitive towards external effects, can be protected by suitable protection devices. In the case of light sources transparent protective materials are envisaged for this purpose.

Furthermore, the invention provides for the heating of one or more mast segments. Difficulties occurring in extending or collapsing the mast at low temperatures, e.g. because of icing up, will thus be counteracted. The heating equipment is at this point also shown independently of the extension of the active area and is regarded as advantageous: it can, for example, be implemented by heating elements. However, in addition to this, the heat produced by the effect of the functional arrangement can be conveniently used. The heating equipment can also comprise a heat conducting connection between the active area and the main body of a mast segment. A heat conducting connection between the mast segments is also in the design.

As well as the mast, the patent is also placing under protection a vehicle fitted with a mast according to the invention.

Further characteristics and advantages of the invention accrue from the description of a specific example by means of the attached diagrams, of which

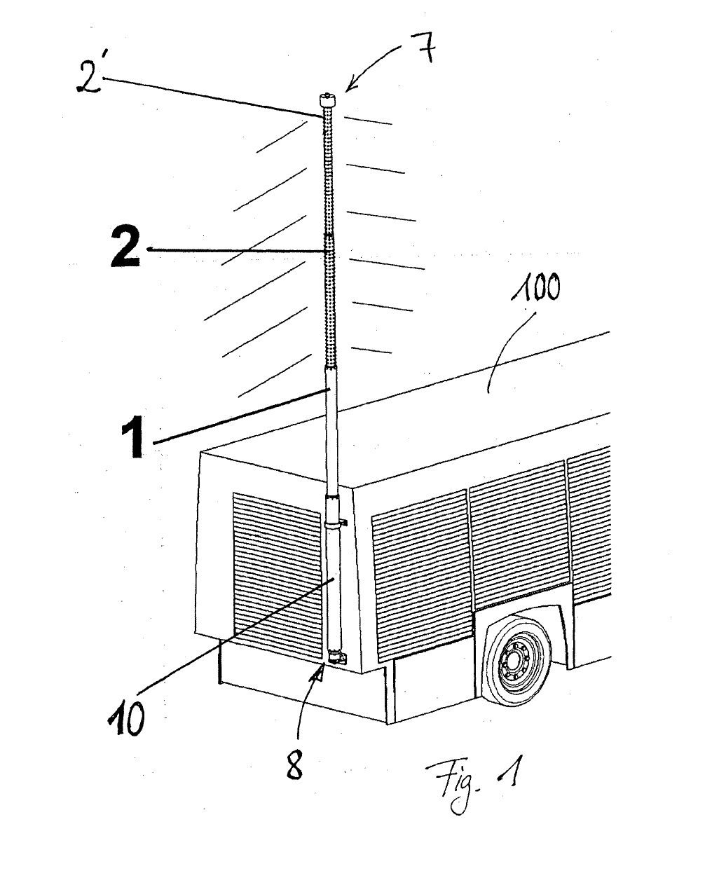

FIG. 1 shows a telescopic mast appropriate to the invention attached to a fire engine, and

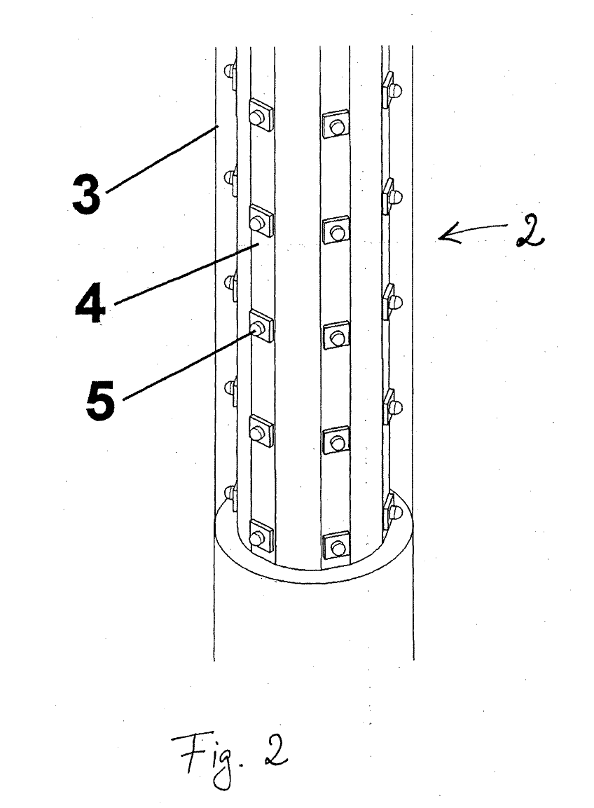

FIG. 2 shows a segment with mounted light sources, these in enlarged view.

In accordance with the diagram in FIG. 1 a telescopic mast consisting of four segments or mast stages is fitted to the rear of an emergency vehicle (100). The four mast stages (10, 1, 2, 2′ from the bottom up) are shown in extended state. Of these, both the upper mast stages (2 and 2′) are mounted with a large number of light sources, which on one side extend up and down over the full length of both mast stages (2, 2′) and also in the peripheral direction over its full extent. As shown in FIG. 1 by the schematically sketched faint lighting rays running downwards, the lamps are designed so that a large part of the light emitted is guided in that direction. The near environment of the mast is illuminated glare-free by this arrangement.

If illumination is no longer required the telescopic mast, which in this example design is a pneumatic mast, is collapsed. The lamps of mast stage 2′ are then surrounded by mast stage 2, which is itself surrounded by mast stage 1. A compact, space saving type of construction, as well as the lighting advantages explained above, is thus achieved through the integrated lamps.

A platform with, for example, a warning light or further searchlights, can be mounted on the mast top (7), if there is a corresponding requirement. Further functional arrangements which can be attached to the mast top can, however, also be done without: the telescopic mast can then be designed for considerably smaller loads.

The mast is secured to the vehicle by means of fixing devices, which are not further described at this point, at the mast foot (8) and approximately at the upper end of the lowest mast stage (10).

In FIG. 2 a part of the mast stage 2 is again shown more precisely. The mast stage consists of a main body (4) formed as a pipe, on which a number of lamps (5) are fitted over a heat conducting connection. The main body (4) can, for example, be made of aluminium, and takes up the heat produced by the lamps when in operation.

A translucent pipe (3), which can for example be made from a synthetic material, serves as protection for the lamps. The pipe (3) forms the outer surface of mast stage 2 and ensures problem free extension and collapsing of the mast, as the penetration of foreign bodies into the intermediate space between the individual lights (5), which would be accessible without the protective pipe (3) and which could otherwise impair the extension mechanism, is prevented.

The specific design described by means of the figures is not to be construed as restrictive. Rather, the characteristics of the invention displayed in the above description, as well as in the claims, can be essential both individually, as well as in any desired combination, for the realisation of the invention in its various design forms.

1. A mast comprising:
a functional arrangement comprising an active area, by which the environment of the mast can be affected and/or an effect on the mast environment can be registered; and
a second segment telescopically displaceable along an axis of the mast relative to a first segment, of the mast and enclosed circumferentially by the first segment with respect to the axis in a collapsed state and comprising an exposed shell area in the extended state,
wherein the active area extends at least partially across the shell area.

2. The mast in accordance with claim 1, further comprising:
a third or more segments, wherein the active area spans more than one segment.

3. The mast in accordance with claim 1, wherein the active area extends over 10% or more, preferably 40% or more and especially 80% or more of the mast height of an extended mast.

4. The mast in accordance with claim 1, wherein the active area extends over the full periphery of the shell area.

5. The mast in accordance with claim 1, wherein the active area comprises several sub-areas separated from one another.

6. The mast in accordance with claim 1, further comprising: a mast top designed for the attachment of further functional arrangements.

7. The mast in accordance with claim 1, further comprising: a mast foot designed for fixing to a vehicle.

8. The mast in accordance with claim 1, wherein the functional arrangement comprises a lighting arrangement, or is made up of such.

9. The mast in accordance with claim 8, wherein the lighting arrangement comprises 12 or more, preferably 60 or more and especially 100 or more, separate light sources.

10. The mast in accordance with claim 9, wherein the light sources have a height density of 4 per metre or more, preferably 20 per metre or more, and especially 50 per metre or more.

11. The mast in accordance with claim 9, wherein the light sources have a peripheral density of 2 or more, preferably 4 or more and especially 6 or more.

12. The mast in accordance with claim 8, wherein the lighting arrangement has an especially height dependent adjustable main radiation direction.

13. The mast in accordance with claim 8, wherein 60% or more, preferably 70% or more and especially 80% or more of the radiation output of the lighting arrangement or a light source is radiated in the angular range π/2≦θ≦π.

14. The mast in accordance with claim 1, further comprising: a device for protection of the active area of the functional arrangement.

15. The mast in accordance with claim 1, further comprising: equipment for heating one or more mast segments which especially utilises the waste heat from heat producing functional arrangements, in particular light sources.

16. The mast in accordance with claim 15, wherein the heating equipment comprises:
a heat conducting connection between the active area and the main body of a mast segment and, optionally, between two mast segments.

17. A vehicle comprising a mast in accordance with claim 1.
